(19) United States
(12) Patent Application Publication
(10) Pub. No.: US 2022/0147617 A1
(43) Pub. Date: May 12, 2022

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventor: Toshiki KOBAYASHI, Tokyo (JP)

(73) Assignee: NEC Corporation, Minato-ku, Tokyo (JP)

(21) Appl. No.: 17/437,636

(22) PCT Filed: Mar. 19, 2019
(86) PCT No.: PCT/JP2019/011366

§ 371 Date: Sep. 9, 2021

(51) Int. Cl. G06F 21/54; G06F 21/55

(52) U.S. Cl. CPC G06F 21/54; G06F 2221/033; G06F 21/554; G06F 21/556

(57) ABSTRACT

An information processing apparatus includes an analysis unit, a storage unit, and a verification unit. The analysis unit analyzes a program before it is executed and extracts a branch in the program. The analysis unit acquires branch information regarding the branch and program part information regarding the part of the program that may be executed from a branch destination of the branch to a next branch part. The storage unit stores the branch information, the program part information, and a first eigenvalue acquired in advance for the program part regarding the program part information. When the program is executed and an execution part reaches the branch, the verification unit acquires a second eigenvalue for the program part. The verification unit determines whether or not the second eigenvalue matches the first eigenvalue, thereby verifying integrity of the program part.

### TECHNICAL FIELD

The present disclosure relates to an information processing apparatus, an information processing method, and a storage medium, and in particular, to an information processing apparatus, an information processing method, and a storage medium for performing verification of a program.

### BACKGROUND ART

As security measures, techniques for verifying whether or not a program has been tampered with have been proposed. In recent years, with the spread of IoT devices, security measures need to be taken even for devices with low computational capabilities such as network cameras or smart meters. These security measures need to deal with low computational capabilities (e.g., Non-Patent Literature 1).

With regard to the above techniques, Patent Literature 1 discloses a tampering detection method capable of detecting tampering with a dynamic storage area. In the method according to Patent Literature 1, address information stored in a dynamic storage area that stores information that may be changed in accordance with execution of processing related to a program code is referred to. When an execution part moves to control based on the information stored in a static storage area, it is checked whether or not the address information that a second tampering detection unit has referred to from the dynamic storage area specifies a range in the static storage area. When the address information that has been referred to does not specify a range in the static storage area, it is determined that address information stored in the dynamic storage area has been tampered with.

### CITATION LIST

### Patent Literature

[Patent Literature 1] Japanese Unexamined Patent Application Publication No. 2011-048851

### Non Patent Literature

[Non-Patent Literature 1] Kobayashi, Toshiki, et al. “SAFES: Sand-boxed Architecture for Frequent Environment Self-measurement.” Proceedings of the 3rd Workshop on System Software for Trusted Execution. ACM, 2018.

### SUMMARY OF INVENTION

### Technical Problem

In the technique disclosed in Patent Literature 1, a part of a program that corresponds to a branch condition of a program has not been taken into account. Accordingly, it is possible that verification may be performed even for a part of a program that is not executed during actual execution of a program, which may cause a verification time to be increased.

The present disclosure has been made in order to solve the above-described problem and the aim of the present disclosure is to provide an information processing apparatus, an information processing method, and a storage medium capable of reducing a verification time for a program.

### Solution to Problem

An information processing apparatus according to the present disclosure includes: analysis means for analyzing a program before it is executed, extracting a branch in the program, and acquiring branch information regarding the branch and program part information regarding the part of the program that may be executed from a branch destination of the branch to a next branch; storage means for storing the branch information, the program part information, and a first eigenvalue that is acquired in advance for the program part regarding the program part information and is used for verification; and verification means for acquiring, when the program is executed and an execution part reaches the branch, a second eigenvalue used for verification for the program part and determining whether or not the second eigenvalue matches the first eigenvalue, thereby verifying integrity of the program part.

Further, an information processing method according to the present disclosure includes: analyzing a program before it is executed, extracting a branch in the program, and acquiring branch information regarding the branch and program part information regarding the part of the program that may be executed from a branch destination of the branch to a next branch; storing the branch information, the program part information, and a first eigenvalue that is acquired in advance for the program part regarding the program part information and is used for verification; and acquiring, when the program is executed and an execution part reaches the branch, a second eigenvalue used for verification for the program part and determining whether or not the second eigenvalue matches the first eigenvalue, thereby verifying integrity of the program part.

Further, a program according to the present disclosure causes a computer to execute: analyzing a program before it is executed, extracting a branch in the program, and acquiring branch information regarding the branch and program part information regarding the part of the program that may be executed from a branch destination of the branch to a next branch; storing the branch information, the program part information, and a first eigenvalue that is acquired in advance for the program part regarding the program part information and is used for verification; and acquiring, when the program is executed and an execution part reaches the branch, a second eigenvalue used for verification for the program part and determining whether or not the second eigenvalue matches the first eigenvalue, thereby verifying integrity of the program part.

### Advantageous Effects of Invention

According to the present disclosure, it is possible to provide an information processing apparatus, an information processing method, and a storage medium capable of reducing a verification time for a program.

### BRIEF DESCRIPTION OF DRAWINGS

FIG. 1 is a diagram showing an outline of an information processing apparatus according to example embodiments of the present disclosure;

FIG. 2 is a block diagram showing functions of an information processing apparatus according to a first example embodiment;

FIG. 3 is a diagram illustrating a table showing verification information stored in a verification information storage unit according to the first example embodiment;

FIG. 4 is a flowchart showing verification processing of the information processing apparatus according to the first example embodiment;

FIG. 5 is a block diagram showing functions of an information processing apparatus according to a second example embodiment;

FIG. 6 is a diagram illustrating a table of a list of data extracted in analysis processing in an analysis unit according to the second example embodiment;

FIG. 7 is a graph showing a structure of a program regarding the table illustrated in FIG. 6;

FIG. 8 is a diagram illustrating a table showing a list of branches aggregated by the analysis unit according to the second example embodiment;

FIG. 9 is a diagram illustrating a table showing verification information stored in a verification information storage unit according to the second example embodiment;

FIG. 10 is a flowchart showing analysis processing executed by the analysis unit according to the second example embodiment;

FIG. 11 is a flowchart showing verification processing of an information processing apparatus according to the second example embodiment;

FIG. 12 is a flowchart showing verification processing of the information processing apparatus according to the second example embodiment; and

FIG. 13 is a block diagram showing functions of an information processing apparatus according to a third example embodiment.

### DESCRIPTION OF EMBODIMENTS

### (Outline of Example Embodiments of Present Disclosure)

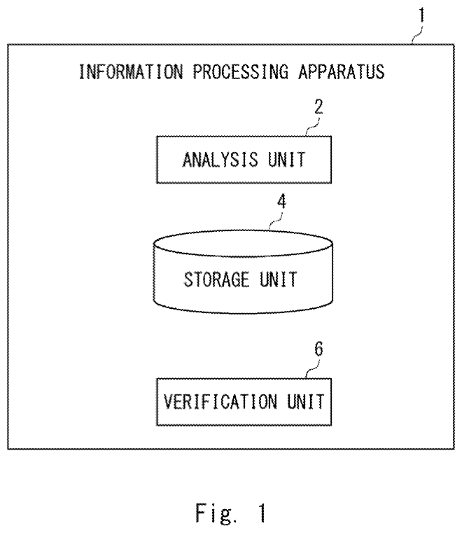

Prior to giving the description of example embodiments of the present invention, an outline of the example embodiments of the present disclosure will be described. FIG. 1 is a diagram showing an outline of an information processing apparatus 1 according to example embodiments of the present disclosure. The information processing apparatus 1 is, for example, a computer. The information processing apparatus 1 includes an analysis unit 2, a storage unit 4, and a verification unit 6. The analysis unit 2 functions as analysis means. The storage unit 4 functions as storage means. The verification unit 6 functions as verification means.

The analysis unit 2 analyzes a program before it is executed and extracts branches in the program. The analysis unit 2 acquires branch information regarding a branch and program part information regarding the part of the program that may be executed from a branch destination of a branch to the next branch. The storage unit 4 stores the branch information, the program part information, and a first eigenvalue acquired in advance for the program part regarding the program part information. Note that the “first eigenvalue” is data that is used for verification of the program part.

When the program is executed and the execution part reaches a branch, the verification unit 6 acquires a second eigenvalue for the program part. Note that the “second eigenvalue” is data used for verification regarding the program part. Then the verification unit 6 verifies integrity of the program part by determining whether or not the second eigenvalue matches the first eigenvalue. The verification unit 6 determines, when the second eigenvalue matches the first eigenvalue, that the program part is not tampered with.

In the following, problems of related art will be described. In the aforementioned Non-Patent Literature 1, the range of the program verification is reduced in accordance with the content of the input and the output. Accordingly, the calculation time required for the verification is reduced. The program verification method according to Non-Patent Literature 1 monitors the input and the output of the device and acquires the content of the input and output. Further, the program verification method according to Non-Patent Literature 1 specifies the part of the program that should be verified in accordance with the above content and performs verification. The program verification method according to Non-Patent Literature 1 calculates, in the verification process, an eigenvalue for the corresponding part and compares the calculated eigenvalue with an eigenvalue stored in advance, thereby verifying the integrity of the program that this program is not tampered with.

In the method disclosed in Non-Patent Literature 1, while the integrity of only a limited program part is verified using the content of the input and the output at timings of the input and the output, branch conditions included in the program are not taken into account. Regarding the part of the program based on the input and the output, only a part of the program that corresponds to each command is verified using an input command or the like. Meanwhile, the problem that branch conditions and the like included in the program are not taken into account is due to a fact that an internal branch condition has not been determined at the timings of the input and the output. This problem may lead to the existence of an amount of calculation that does not require verification and that can be reduced since verification is performed also on a part of a program that is not executed during actual execution of a program. This may cause a verification time and power consumption to be increased. On the other hand, by acquiring information on the branches, it is possible to verify, besides integrity of the program, integrity of the execution flow of the program. This verification of the integrity of the execution flow of the program leads to detection of abuse of the program and thus the device can be made more robust. In the following description, the verification of the integrity of the program is referred to as a “first integrity check” and the verification of the integrity of the execution flow of the program is referred to as a “second integrity check”.

As described above, the information processing apparatus 1 according to the example embodiments of the present disclosure analyzes a program in advance and collects information on the branches in the program and the part of the program that is executed after each of the branches. Further, the information processing apparatus 1 verifies the integrity of the corresponding part of the program at each branch point during the execution of the program. Accordingly, the information processing apparatus 1 verifies the integrity of the program and the integrity of the execution flow of the program in the information processing apparatus 1. Accordingly, the information processing apparatus 1 is able to perform the first integrity check in which branches of the program are taken into account. Accordingly, the information processing apparatus 1 prevents the program parts that do not need to be verified from being verified, whereby it is possible to reduce a verification time for a program. Further, the information processing method executed by the information processing apparatus 1 and the program that executes the information processing method are also able to reduce a verification time for a program.

Further, the information processing apparatus 1 verifies the integrity of the corresponding part of the program and the integrity of the execution flow of the program at each branch point during the execution of the program. Specifically, the storage unit 4 stores branch information including a pair of a branch source address and a branch destination address. Then the verification unit 6 verifies integrity of the execution flow of the program by determining whether or not a pair of a branch source address and a branch destination address of the program that is being executed is present in the storage unit 4. Accordingly, the information processing apparatus 1 verifies the integrity of the program and the integrity of the execution flow of the program in the information processing apparatus 1. Accordingly, the information processing apparatus 1 is able to concurrently execute, besides the first integrity check, the second integrity check, whereby it is possible to efficiently perform verification of a program more definitely.

### First Example Embodiment

Hereinafter, with reference to the drawings, example embodiments will be described. For the sake of clarification of the descriptions, the following description and the drawings are omitted and simplified as appropriate. Further, throughout the drawings, the same components are denoted by the same reference symbols and overlapping descriptions will be omitted as necessary.

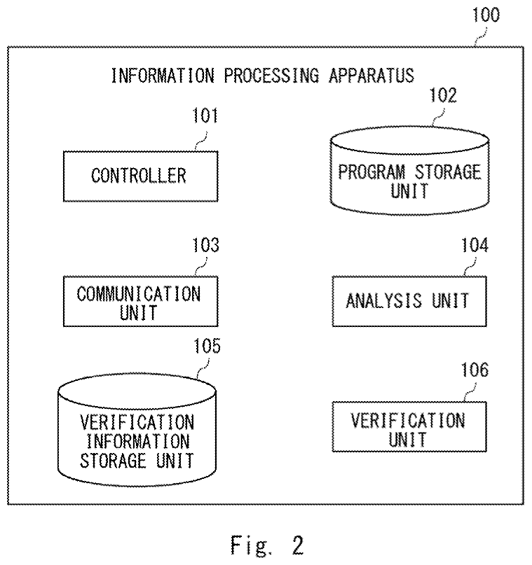

FIG. 2 is a block diagram showing functions of an information processing apparatus 100 according to a first example embodiment. The information processing apparatus 100 is, for example, a computer. The information processing apparatus 100 may implement components shown in FIG. 2 by executing a software program in a central processing unit. Further, each of the components implemented in the information processing apparatus 100 may be implemented as an individual device, a functional unit, or an electronic circuit. The same holds true for other example embodiments that will be described later.

The information processing apparatus 100 includes a controller 101, a program storage unit 102, a communication unit 103, an analysis unit 104, a verification information storage unit 105, and a verification unit 106. The analysis unit 104, the verification information storage unit 105, and the verification unit 106 respectively correspond to the analysis unit 2, the storage unit 4, and the verification unit 6 shown in FIG. 1.

The controller 101 is a control apparatus that performs overall control and arithmetic processing of the information processing apparatus 100. The program storage unit 102 is a storage apparatus that stores a program executed in the controller 101. The communication unit 103 performs communication with a connected device via a network (not shown) such as the Internet.

The analysis unit 104 analyzes the program stored in the program storage unit 102 in advance (before execution of the program) and extracts branch parts. In addition, the analysis unit 104 inserts a call to the verification unit 106 immediately before or after each branch in the program. Note that the analysis unit 104 may extract, as branches, only conditional branches, or may extract all the instructions related to an execution flow of the program such as function calls, return, and conditional jumps. Further, the analysis unit 104 may set conditional branches related to loop processing of short instructions and loop processing that does not include I/O processing and is thus not likely to be attacked as exempt from branch extraction. Note that a call to the verification unit 106 may be described as an instruction in an actual program, may be set so as to interrupt as a breakpoint, or may be set so as to interrupt at a specific timing using a debug port.

Further, as an example of branch extraction analysis, for example, when a source code is available, the analysis unit 104 may extract branches by extracting specific syntax such as an IF sentence and a WHILE sentence and collecting the corresponding address number in binary data having an execution form after compilation. Further, when, for example, there is no source code and only binary data is available, the analysis unit 104 may extract branches by conducting disassembling and collecting an address number for a specific instruction set such as CALL and JMP instructions.

The analysis unit 104 acquires, based on the obtained branch parts, branch destinations from each branch part and a part of a program (program part) that is executed from each branch destination to the next branch part. Then the analysis unit 104 stores (registers) these information items in the verification information storage unit 105. Further, the analysis unit 104 acquires information on the branch destinations that may branch from each branch part and stores (registers) the acquired information in the verification information storage unit 105. In this example embodiment, the analysis unit 104 is included in the information processing apparatus 100. However, another apparatus such as an information processing apparatus provided outside the information processing apparatus 100 may serve as the analysis unit 104.

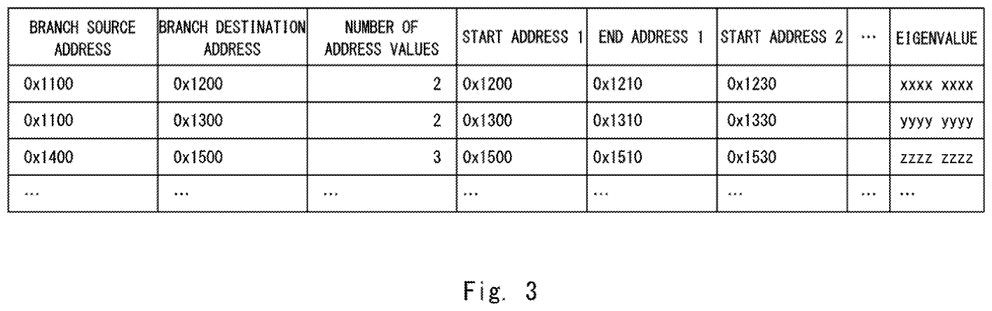

The verification information storage unit 105 stores verification information including information on each branch part (branch information) and information on a part of a program (program part information) registered by the analysis unit 104. Specifically, the verification information storage unit 105 stores a table as illustrated in FIG. 3.

FIG. 3 is a diagram illustrating a table showing verification information stored in the verification information storage unit 105 according to the first example embodiment. As illustrated in FIG. 3, the table stored in the verification information storage unit 105 includes a pair of an address value of a branch source (branch source address) and an address value of a branch destination (branch destination address), the number of address values, one or more start addresses and end addresses, and an eigenvalue.

In the table illustrated in FIG. 3, for each pair of the branch source address and the branch destination address, address values of a part of a program executed before the next branch destination are stored. In the example shown in FIG. 3, the verification information storage unit 105 stores the address values of the program part by a start address value and an end address value, consecutive address values being lumped. Further, in the example shown in FIG. 3, the verification information storage unit 105 registers the number of start addresses as the number of address values. As the method of storing the address values, a start address value and a size may be stored. Further, the address value here means an address value of a physical memory or an address value of a virtual memory, when a program is executed. When, for example, there is an OS and a program operates on a virtual memory, an address value of the virtual memory may correspond to the “address value”. On the other hand, in a system that does not include a virtual memory, an address of a physical memory may correspond to the “address value”.

Further, as shown in FIG. 3, the verification information storage unit 105 stores an eigenvalue for the part of the program (hereinafter this value will also be referred to as a first value). The first value corresponds to the “first eigenvalue”. The first value is acquired (calculated) before the program is executed and is used in a first integrity check. The first value may be an index value that can be calculated from the entity (e.g., binary data) of the program stored in the program storage unit 102 and with which it can be checked whether or not the program has been tampered with. The index value may be, for example, a hash value, a check sum, or a value of an error correction code. Further, the first value may be the entity itself of the program.

The verification unit 106 is called when the execution part reaches a branch during the execution of the program and performs a first integrity check and a second integrity check. That is, the verification unit 106 starts processing in accordance with the call inserted by the analysis unit 104, during the execution of the program. As the second integrity check, the verification unit 106 checks to where the program is about to branch and checks the integrity of the branch information regarding the branch of the program that is being executed and the branch information stored in the verification information storage unit 105. Specifically, the verification unit 106 checks whether or not a pair of the current (that is, the program that is being executed) branch source address and the branch destination address is included in a pair of the branch source address and the branch destination address stored in the verification information storage unit 105. When the current pair of the branch source address and the branch destination address is included in the verification information storage unit 105, the verification unit 106 determines that the verification has been successfully completed, that is, there is no fraud regarding the execution flow of the program in the information processing apparatus 100.

Further, the verification unit 106 performs the first integrity check on a part of a program that corresponds to the current pair of the branch source address and the branch destination address. In the first integrity check, the verification unit 106 calculates (acquires), regarding the program that is being executed, an eigenvalue (hereinafter this value will also be referred to as a second value) of a part of the program specified by an address range stored in the verification information storage unit 105. The second value corresponds to a “second eigenvalue”. The method of calculating the second value may be the same as the method of calculating the first value. That is, when the first value is a hash value, the second value may also be a hash value. The verification unit 106 determines whether or not the verification has been successfully completed by comparing the second value with the first value stored in the verification information storage unit 105. When the first value matches the second value, the verification unit 106 determines that the verification has been successfully completed, i.e., that there is no fraud regarding a program in the information processing apparatus 100.

When the first integrity check or the second integrity check has failed, the verification unit 106 reports a security violation. That is, the verification unit 106 reports a security violation when a pair of the branch destination address and the branch source address regarding the program that is being executed is not present in the verification information storage unit 105 or when the first value does not match the second value. As an example of the report of the security violation, the verification unit 106 generates a software violation interruption inside the information processing apparatus 100, records a log of security violations, reports abnormality to the outside via the communication unit 103 or the like. In this example embodiment, after the security violation is reported, the program is no longer executed and execution of the program is stopped. However, execution of the program may continue after a violation is reported.

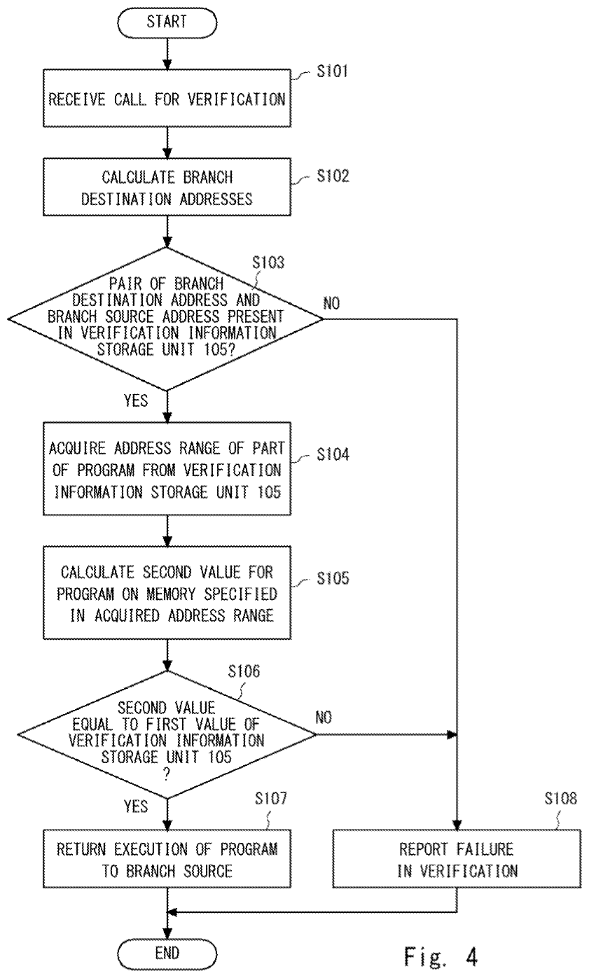

FIG. 4 is a flowchart showing verification processing of the information processing apparatus 100 according to the first example embodiment. This processing is executed by the verification unit 106. First, the verification processing is started when the execution part reaches a branch during the execution of the program of the controller 101 and the verification unit 106 receives a call for the verification (Step S101). Accordingly, the processing of the verification unit 106 is started. The verification unit 106 that is called calculates the branch destination addresses of the above branch that the execution part reaches (Step S102). Then the verification unit 106 performs the second integrity check. That is, the verification unit 106 determines whether or not the pair of the branch source address and the branch destination address obtained here is present in the verification information storage unit 105 (Step S103).

When a pair of the branch source address and the branch destination address is not present in the verification information storage unit 105 (NO in S103), the verification unit 106 determines that the verification has failed. Then, the process proceeds to S108. On the other hand, when there is a corresponding item in the verification information storage unit 105 (YES in S103), the verification unit 106 acquires a range of an address that corresponds to the part of the program (Step S104). Then the verification unit 106 performs a first integrity check. That is, the verification unit 106 calculates the second value for a program that is present on a memory in the acquired address range (Step S105) and determines whether or not the obtained second value is equal to the first value of the verification information storage unit 105 (Step S106).

When the first value is equal to the second value (YES in S106), the verification unit 106 determines that the verification has been successfully completed. Accordingly, the verification unit 106 returns the execution of the program to the caller of the verification unit 106, i.e., the branch source, and ends the verification (Step S106). On the other hand, when the first value and the second value are not equal to each other (NO in S106), the verification unit 106 determines that the verification has failed. When a violation has been detected in the first integrity check (S106) or the second integrity check (S103) (NO in S103, NO in S106), the verification unit 106 reports a failure in the verification and ends the verification processing (Step S108).

As described above, the information processing apparatus 100 according to the first example embodiment performs verification of the integrity of the program and verification of the integrity of the execution flow of the program, that is being executed by the controller 101 in each of the branches using the results of analyzing the program as verification information. Accordingly, as compared to the case in which integrity of a part of a program is verified based on the input and the output as disclosed in Non-Patent Literature 1, it is possible to perform verification for a part of the program having a smaller range and verify the integrity of the execution flow for a branch at the same time. That is, the information processing apparatus 100 compares the first value acquired for the program part that corresponds to the branch information obtained as a result of analyzing the program with the second value acquired for the program in the address range that corresponds to this program part. Accordingly, by performing verification for each of the program parts, it is possible to perform verification for a part of the program having a smaller range as compared to the case in which integrity of a part of a program is verified based on the input and the output as disclosed in Non-Patent Literature 1. Accordingly, it becomes possible to reduce the verification time.

Further, the analysis unit 104 acquires branch information including a pair of a branch source address and a branch destination address by analyzing the program and stores the acquired branch information in the verification information storage unit 105. Then the verification unit 106 performs verification of the integrity of the execution flow of the program by determining whether or not a pair of the branch source address and the branch destination address regarding the program that is being executed is present in the verification information storage unit 105. Accordingly, the second integrity check can be executed in addition to the first integrity check at a timing the same as the timing when the first integrity check is executed, whereby it is possible to efficiently perform verification of a program more definitely.

### Second Example Embodiment

Next, with reference to the drawings, a second example embodiment will be described. For the sake of clarification of the descriptions, the following description and the drawings are omitted and simplified as appropriate. Further, throughout the drawings, the same components are denoted by the same reference symbols and overlapping descriptions will be omitted as necessary. Accordingly, in the following description, points different from those described in the first example embodiment will be described.

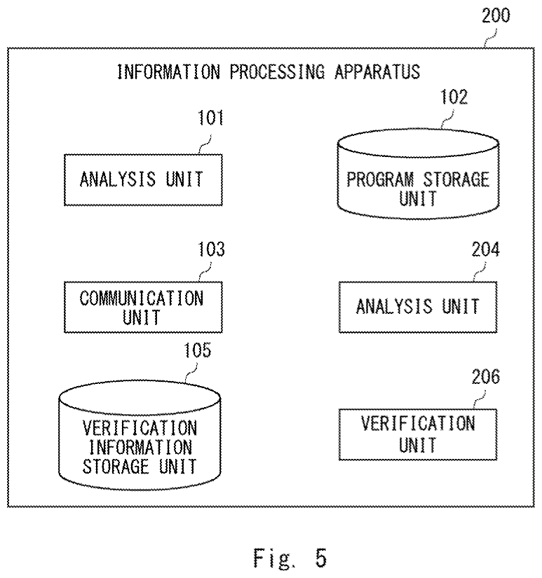

FIG. 5 is a block diagram showing functions of an information processing apparatus 200 according to the second example embodiment. The information processing apparatus 200 includes a controller 101, a program storage unit 102, a communication unit 103, an analysis unit 204, a verification information storage unit 105, and a verification unit 206. The analysis unit 204, the verification information storage unit 105, and the verification unit 206 respectively correspond to the analysis unit 2, the storage unit 4, and the verification unit 6 shown in FIG. 1.

In the second example embodiment, the analysis unit 204 analyzes, in the preliminary analysis, a timing when a branch condition is determined (i.e., fixed) for each branch. In accordance with this timing, the verification unit 206 aggregates a plurality of branches as a verification target. According to this aggregation, it is possible to reduce the number of times the verification processing is called by the information processing apparatus 200. Accordingly, it becomes possible to reduce the calculation time (verification time) required for each call for verification processing regardless of the size of the verification area.

For example, for each branch condition, a branch destination has already been determined (i.e., fixed) immediately before a determination of the branch condition. If the instruction immediately before the determination is such an instruction that does not change the branch condition, the branch destination has already been determined (i.e., fixed) before this instruction. A timing immediately after the execution of the instruction that corresponds to the timing immediately before the determination of the branch condition when the above instruction that does not change the branch condition is omitted is assumed to be the timing when the branch destination is determined (i.e., fixed). If, at a timing when one branch condition is determined, the next branch condition executed after that has already been determined (i.e., fixed), the verification unit 206 concurrently determines the two branch conditions and collectively performs verification. Collecting two branch conditions in the above manner is referred to as aggregation of branches. While two branch conditions are aggregated in the example according to the second example embodiment, two or more branches may be actually aggregated.

The analysis unit 204 analyzes, for a pair of the branch source address and the branch destination address extracted in a way similar to that in the first example embodiment, the branch determination address and the branch condition that correspond to the timing when the branch condition is determined (i.e., fixed). Further, the analysis unit 204 analyzes the next branch source address that corresponds to a branch that appears next to the branch destination address. A technique called program slicing in which only a part having data dependencies and control dependencies with respect to a specific instruction or data in a program is extracted may be used for analyzing the branch determination address. When, for example, a specific instruction in a source code is specified, other instructions that deal with data included in the instructions are extracted as instructions having data dependencies. Further, for example, other instructions regarding whether or not the specified instruction is executed are extracted as instructions having control dependencies. By recursively extracting data or an instruction having data dependencies or control dependencies, a part related to the specified instruction is extracted from the entire program. By performing the above program slicing on the determination part of the branch condition, a part of the program related to the branch condition is extracted. By checking the execution flow of a part of this program, the branch determination address may be extracted as an execution timing of an instruction where data related to the branch condition is handled at last.

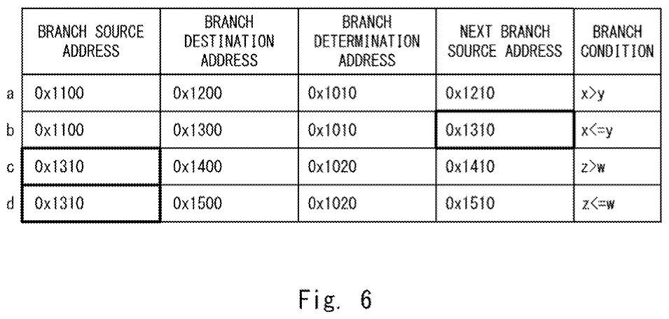

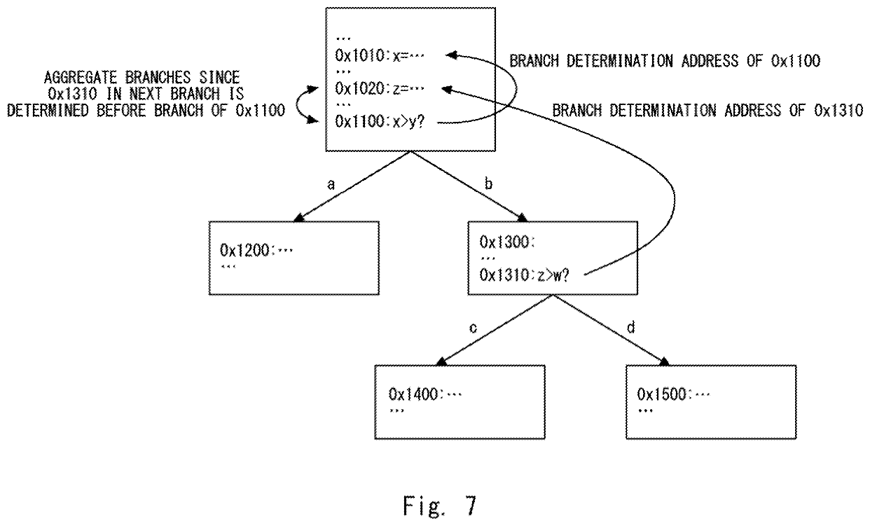

FIG. 6 is a diagram illustrating a table of a list of data extracted in analysis processing of the analysis unit 204 according to the second example embodiment. Further, FIG. 7 is a graph showing a structure of a program regarding the table illustrated in FIG. 6. As illustrated in FIG. 6, the data extracted in the analysis processing includes, for each of the branches a-d, a branch source address, a branch destination address, a branch determination address, a next branch source address, and a branch condition. While a single branch determination address is obtained in the example shown in FIG. 6, a plurality of addresses that are parallel to each other may be actually extracted.

For example, for the branches a and b, if the value of x of the address “0x1010” is determined, it is determined whether the branch destination address for the branch source address “0x1100” is “0x1200” (x>y) or “0x1300” (x≤y). Accordingly, the branch determination address of the branch a (branch destination address “0x1200”) and the branch b (branch destination address “0x1300”) of the branch source address “0x1100” is “0x1010”. Further, for the branch a, the branch source address that is next to the branch destination address “0x1200” is “0x1210”. For the branch b, the branch sources address that is next to the branch destination address “0x1300” is “0x1310”.

Further, for the branches c and d, if the value of z of the address “0x1020” is determined, it is determined whether the branch destination address for the branch source address “0x1310” is “0x1400” (z>w) or “0x1500” (z≤w). Therefore, the branch determination address of the branch c (branch destination address “0x1400”) and the branch d (branch destination address “0x1500”) of the branch source address “0x1310” is “0x1020”.

Next, the analysis unit 204 searches for a pair of branches that can be aggregated from the data extracted in the analysis processing, as illustrated in FIG. 6. The pair of branches that can be aggregated means a combination of the branch A and the branch B where, for one branch A, a branch condition of the branch B, which is the branch next to the branch A, is determined (i.e., fixed) before the determination of the condition of the branch A. As a procedure, first, the analysis unit 204 extracts a pair of branches that are executed consecutively in sequence. Specifically, the analysis unit 204 selects the branch A and the branch B and searches for a combination in which the next branch source address of the branch A matches the branch source address of the branch B. In the example shown in FIG. 6, for example, data such as “0x1310” shown in the thick frame corresponds to the above. That is, the next branch source address of the branch b matches the branch sources address of the branch c and the branch d. Therefore, the branch b corresponds to the aforementioned branch A and the branch c and the branch d correspond to the aforementioned branch B. That is, the analysis unit 204 searches for a combination of the branch b with the branch c and a combination of the branch b with the branch d.

Next, the analysis unit 204 determines whether or not the branch A and the branch B can be aggregated. Specifically, the analysis unit 204 regards that two branches can be aggregated when the branch determination address of the branch B appears earlier on the execution flow than the branch source address of the branch A does. For example, regarding the pair of the branch b and the branches c and d in the examples shown in FIGS. 6 and 7, for the branch source address “0x1100” of the branch b, the branch determination address “0x1020” of the branches c and d appears first. Accordingly, the analysis unit 204 determines that the branch b and the branch c can be aggregated and the branch b and the branch d can be aggregated.

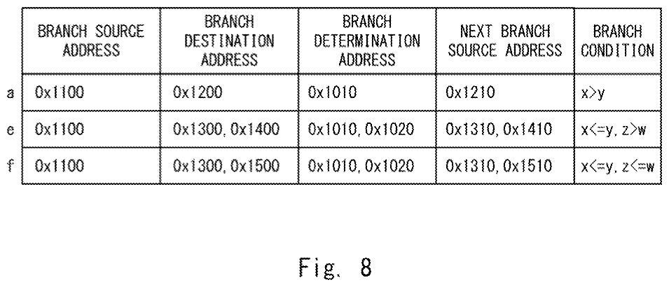

FIG. 8 is a diagram illustrating a table showing a list of branches aggregated by the analysis unit 204 according to the second example embodiment. The analysis unit 204 aggregates two branches that can be aggregated. Specifically, as illustrated in FIG. 8, the analysis unit 204 stores the branch determination addresses, the next branch source addresses, the branch destination addresses, and the branch condition of the branch A and the branch B in such a form that all of them are listed. For example, the branches b and c shown in FIG. 6 are aggregated as a branch e. Further, the branches b and d shown in FIG. 6 are aggregated as a branch f. Since the branch a cannot be aggregated with any branch, the data in the branch a is the same as that shown in FIG. 6. Regarding the branch determination addresses and the next branch source addresses that are listed, only the addresses of the branch B (branches c and d) may be stored so that the amount of information may be saved. Further, the analysis unit 204 may store, as verification information, a memory address where each variable value is stored, information on the data type, or an instruction set required for actually performing evaluation, in such a way that the branch conditions can be specifically evaluated in the program.

The analysis unit 204 repeats aggregation processing until there are no longer any combinations of branches that can be aggregated. After that, like in the first example embodiment, the analysis unit 204 calculates the number of address values for the part of the program, a pair of the start address and the end address, and the first value (eigenvalue) and stores the results of the calculation in the verification information storage unit 105.

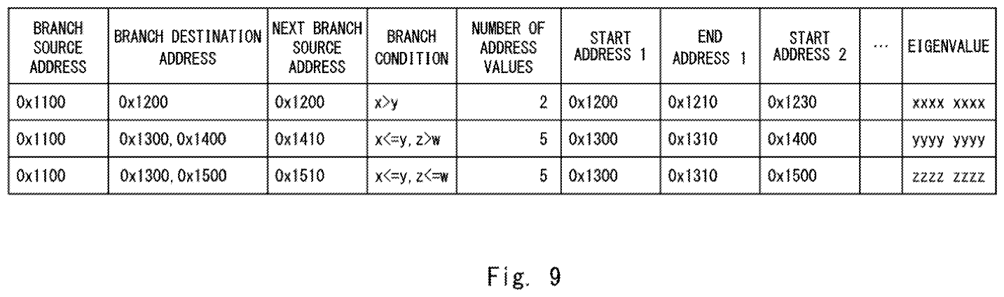

FIG. 9 is a diagram illustrating a table showing verification information stored in the verification information storage unit 105 according to the second example embodiment. As illustrated in FIG. 9, the table stored in the verification information storage unit 105 according to the second example embodiment includes a pair of the branch source address and a branch destination address, a next branch source address, a branch condition, the number of address values, one or more start addresses and an end address, and an eigenvalue. The branch determination address may be omitted since it is not necessary for verification. Further, regarding the next branch source address, only those that appear last may be stored.

Further, the analysis unit 204 inserts a call to the verification unit 206 into the branch source address after the aggregation as a timing when the verification is performed. The call to the verification unit 206 may be described as an instruction in the actual program, may be set so as to interrupt as a breakpoint, or may be set so as to interrupt at a specific timing using a debug port.

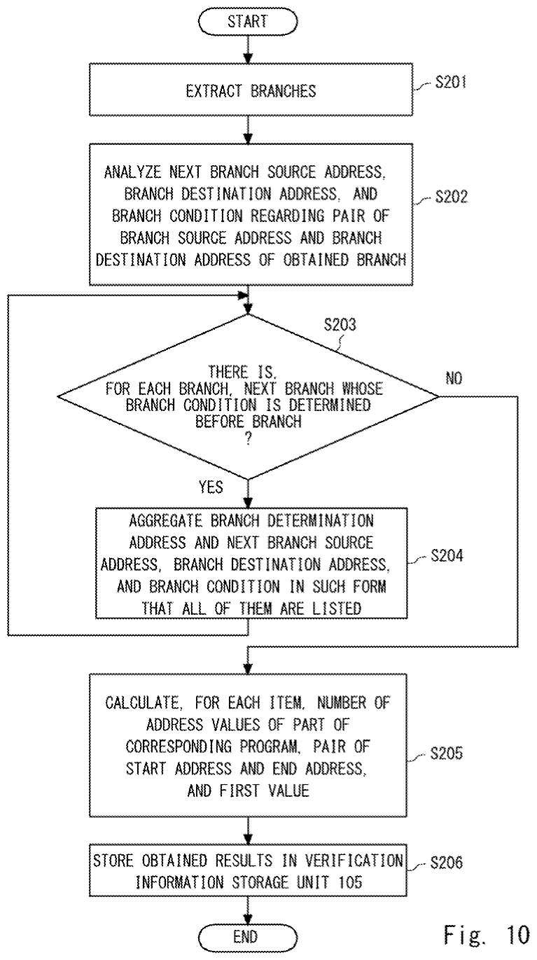

FIG. 10 is a flowchart showing analysis processing executed by the analysis unit 204 according to the second example embodiment. First, the analysis unit 204 extracts branches in a program (Step S201). Next, the analysis unit 204 analyzes the next branch source address, the branch determination address, and the branch condition regarding a pair of the branch source address and the branch destination address of the obtained branch (Step S202). Then, the analysis unit 204 determines, for each branch, whether or not there is a next branch whose branch condition is determined (i.e., fixed) before the branch (Step S203). When there is such a branch (YES in S203), the analysis unit 204 aggregates the branch determination address and the next branch source address, the branch destination address, and the branch condition in such a form that all of them are listed (Step S204). Then the process returns to S203.

When there is no longer any branches to be aggregated (NO in S203), the analysis unit 204 calculates, for each item, the number of address values of the part of the corresponding program, a pair of a start address and an end address, and a first value (eigenvalue) (Step S205). The analysis unit 204 stores the obtained results in the verification information storage unit 105 and ends the analysis processing (Step S206).

The verification unit 206 (FIG. 5) performs, besides the verification processing performed by the verification unit 106 according to the first example embodiment, calculation of a branch destination address for the program that is being executed, based on branch conditions indicated in data stored in the verification information storage unit 105. The verification unit 206 acquires, for the item that corresponds to the branch destination address that has been calculated, an address range of the program part and calculates the second value. The verification unit 206 determines whether or not the verification has been successfully completed by comparing the obtained second value with the first value. When the first value matches the second value, the verification unit 206 determines that the first integrity check has been successfully completed, that is, there is no fraud regarding a program in the information processing apparatus 100.

Furthermore, the verification unit 206 stores the next branch source address regarding the program that is being executed in the verification information storage unit 105 after the verification. This next branch source address is used by the verification unit 206 called in the next branch to determine whether or not the execution part has correctly reached the branch expected in the previous verification. That is, at a time of call for the verification, the verification unit 206 checks the presence or the absence of the stored next branch source address and confirms that the stored next branch source address correctly matches the current branch source address, thereby performing verification of the execution flow of aggregated branches. Therefore, as the second integrity check according to the second example embodiment, comparison between the current branch source address and the stored next branch source address is performed besides the second integrity check according to the first example embodiment.

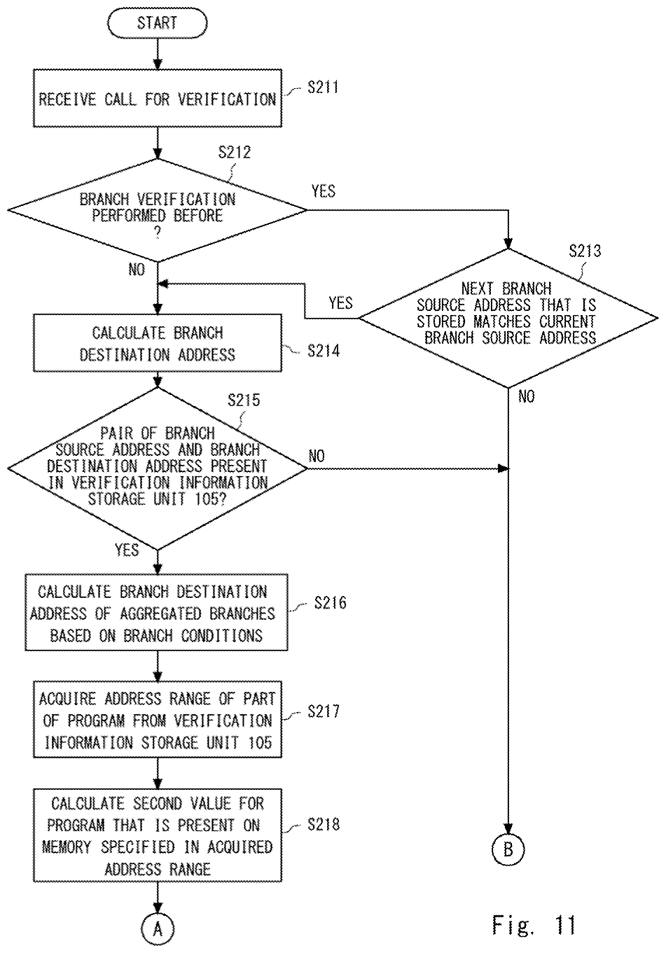

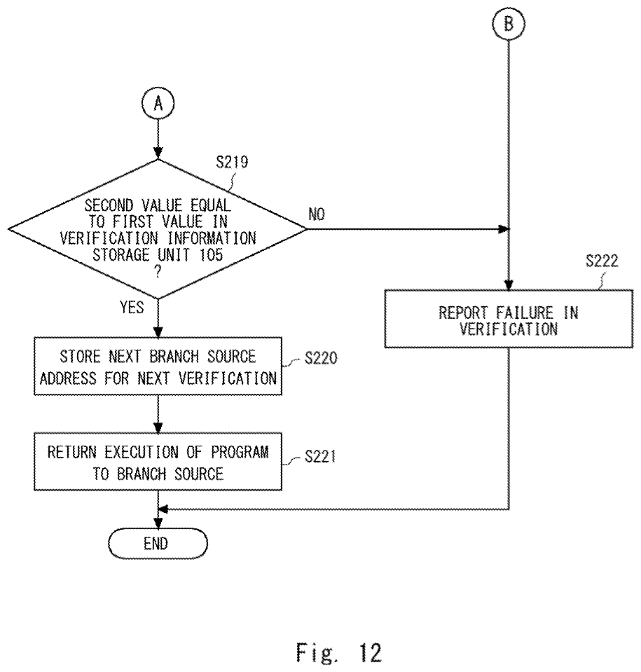

FIGS. 11 and 12 are flowcharts showing verification processing of the information processing apparatus 200 according to the second example embodiment. This processing is executed by the verification unit 206. First, the verification processing is started when the execution part reaches a branch during the execution of the program of the controller 101 and the verification unit 206 receives a call for the verification (Step S211). The processing of the verification unit 206 is thus started. The called verification unit 206 determines whether or not the verification (branch verification) has been performed before (Step S212). Specifically, the verification unit 206 determines whether or not the next branch source address is stored since the processing in S220 that will be described later has been performed in the previous branch verification. When the next branch source address is not stored, that is, when the verification has not been performed (NO in S212), the processing in S213 is not performed and the process proceeds to S214.

On the other hand, when the next branch source address is stored, i.e., when the verification has been performed (YES in S212), the verification unit 206 determines, as a second integrity check, whether or not the next branch source address that is stored matches the current branch source address (Step S213). When they do not match (NO in S213), the verification unit 206 determines that the verification has failed. Accordingly, the process proceeds to S222. On the other hand, when they match each other (YES in S213), the process proceeds to S214, where the verification unit 206 continues to execute the verification processing.

The verification unit 206 calculates the branch destination address of the current branch (Step S214). The verification unit 206 determines, as a second integrity check, whether or not the pair of the branch source address and the branch destination address obtained here is present in the verification information storage unit 105 (Step S215). When a pair of the branch source address and the branch destination address is not present in the verification information storage unit 105 (NO in S215), the verification unit 206 determines that the verification has failed. Accordingly, the process proceeds to S222.

On the other hand, when there is a corresponding item in the verification information storage unit 105 (YES in S215), the verification unit 206 calculates the branch destination address of the aggregated branches based on the branch conditions described in the verification information storage unit 105 (Step S216). The verification unit 206 acquires a range of an address of the part of the program that corresponds to the pair of the obtained branch destination addresses (Step S217). Then the verification unit 206 performs a first integrity check. That is, the verification unit 206 calculates the second value for a program that is present on a memory in the acquired address range (Step S218) and determines whether the obtained second value is equal to the first value in the verification information storage unit 105 (Step S219).

When the first value is equal to the second value (YES in S219), the verification unit 206 determines that the verification has been successfully completed. In this case, the verification unit 206 stores the next branch source address (Step S220) for the next verification (S213). After that, the verification unit 206 returns the execution of the program to the caller of the verification unit 206, i.e., the branch source, and ends the verification (Step S221). On the other hand, when the first value is not equal to the second value (NO in S219), the verification unit 206 determines that the verification has failed. When a violation has been detected in the first integrity check or the second integrity check (NO in S219, NO in S213, and NO in S215), the verification unit 206 reports a failure in the verification and ends the verification processing (Step S222).

As described above, the information processing apparatus 200 according to the second example embodiment performs, for the aggregated branch information, verification of the integrity of the program and verification of the integrity of the execution flow of the program, that is being executed by the controller 101, using the results of analyzing the program as verification information. It is therefore possible to execute the first integrity check and the second integrity check with fewer calls for validation than in the first example embodiment. Accordingly, with the information processing apparatus 200 according to the second example embodiment, it is possible to further reduce the verification time as compared to the case described in the first example embodiment.

Further, the information processing apparatus 200 according to the second example embodiment stores, after the verification, the next branch source address regarding the program that is being executed. Then, the stored next branch source address is used by the verification unit 206 that has been called in the next branch to determine whether or not the execution part has correctly reached the branch expected in the previous verification. That is, when the verification for the first branch has been successfully completed, the verification unit 206 stores branch information (next branch source address) regarding the next branch (the second branch) whose branch condition has been determined (i.e., fixed). Then the verification unit 206 verifies integrity of the execution flow of the program using the stored branch information when the branch (second branch) next to the first branch is verified. Accordingly, the information processing apparatus 200 according to the second example embodiment further compares the branch source address with the stored next branch source address, as a second integrity check. Accordingly, the information processing apparatus 200 according to the second example embodiment is able to efficiently perform verification of a program more definitely as compared to the case in the first example embodiment.

### Third Example Embodiment

Next, with reference to the drawings, a third example embodiment will be described. For the sake of clarification of the descriptions, the following description and the drawings are omitted and simplified as appropriate. Further, throughout the drawings, the same components are denoted by the same reference symbols and overlapping descriptions will be omitted as necessary. Accordingly, in the following description, points different from those of the aforementioned first and second example embodiments will be described.

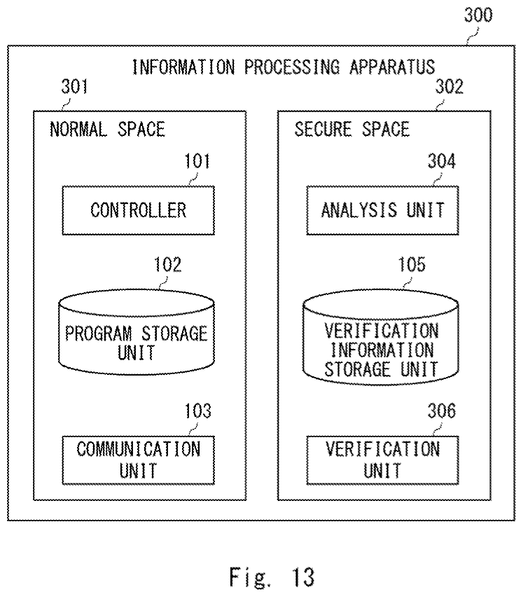

FIG. 13 is a block diagram showing functions of an information processing apparatus 300 according to third example embodiment. The information processing apparatus 300 includes a controller 101, a program storage unit 102, a communication unit 103, an analysis unit 304, a verification information storage unit 105, and a verification unit 306. The information processing apparatus 300 further includes a normal space 301, which is a normal program execution environment, and a secure space 302. The secure space 302 is a secure execution environment in which access from the normal space 301 is restricted in terms of hardware. The secure space 302 may be constructed by using, for example, Intel SGX (Software Guard Extensions) or ARM Trust Zone (registered trademark).

The controller 101, the program storage unit 102, and the communication unit 103 are installed in the normal space 301. On the other hand, the analysis unit 304, the verification information storage unit 105, and the verification unit 306 are installed in the secure space 302. In this example embodiment, the analysis unit 304 is included in the information processing apparatus 300. However, another reliable apparatus such as an information processing apparatus outside the information processing apparatus 300 may serve as the analysis unit 304.

Just like the analysis unit 104 according to the first example embodiment, the analysis unit 304 registers the verification information in the verification information storage unit 105. Further, the analysis unit 304 registers an address value of a call to the verification unit 306 embedded in each of the branches in the program and the first value of the part of the program that corresponds to this address value, in the verification information storage unit 105. That is, the verification information storage unit 105 stores the first value (first eigenvalue) regarding a call for verification.

Just like the verification unit 106 according to the first example embodiment, the verification unit 306 is called when the execution part reaches a branch during the execution of the program executed by the controller 101 and performs the aforementioned verification. Further, the verification unit 306 checks the integrity of the part of the program that calls the verification unit 306 for each branch in a specific set cycle. That is, the verification unit 306 periodically calculates the second value (second eigenvalue) regarding the call for the verification. The verification unit 306 then verifies the integrity of the call for the verification by comparing the calculated second value with the first value stored in the verification information storage unit 105.

As described above, the information processing apparatus 300 according to the third example embodiment is configured to periodically monitor a call to the verification unit 306. Accordingly, it is possible to detect invalidation of a call to the verification unit 306 in the program in a non-secure execution environment.

### Modified Examples

Note that the present disclosure is not limited to the above example embodiments and may be changed as appropriate without departing from the spirit of the present disclosure. For example, one or more of the processes of each step of the flowchart described above may be omitted. For example, the processing of S103 shown in FIG. 4 may be omitted. However, execution of the processing in S103 (second integrity check) enables verification processing of a program to be performed more definitely. The same holds true for the processing of S215 and the processing of S212 and S213 shown in FIG. 11.

In the above-described examples, the program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-ROM, CD-R, CD-R/W, and semiconductor memories (such as mask ROM, Programmable ROM (PROM), Erasable PROM (EPROM), flash ROM, RAM, etc.). Further, the program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present disclosure has been described with reference to the example embodiments, the present disclosure is not limited to the aforementioned example embodiments. Various changes that can be understood by those skilled in the art can be made to the configurations and the details of the present disclosure within the scope of the present disclosure.

The whole or part of the example embodiments disclosed above can be described as, but not limited to, the following supplementary notes.

(Supplementary Note 1)

An information processing apparatus comprising:

analysis means for analyzing a program before it is executed, extracting a branch in the program, and acquiring branch information regarding the branch and program part information regarding the part of the program that may be executed from a branch destination of the branch to a next branch;

storage means for storing the branch information, the program part information, and a first eigenvalue that is acquired in advance for the program part regarding the program part information and is used for verification; and

verification means for acquiring, when the program is executed and an execution part reaches the branch, a second eigenvalue used for verification for the program part and determining whether or not the second eigenvalue matches the first eigenvalue, thereby verifying integrity of the program part.

(Supplementary Note 2)

The information processing apparatus according to Supplementary Note 1, wherein

the storage means stores the branch information including a pair of a branch source address and a branch destination address, and

the verification means verifies the integrity of an execution flow of the program by determining whether or not a pair of a branch source address and a branch destination address of the program that is being executed is present in the storage means.

(Supplementary Note 3)

The information processing apparatus according to Supplementary Note 1 or 2, wherein

the analysis means analyzes a timing when a branch condition of the branch in a program is determined and aggregates a plurality of branches, and

the verification means verifies the integrity of the program part for each of the branches that have been aggregated.

(Supplementary Note 4)

The information processing apparatus according to Supplementary Note 3, wherein the analysis means aggregates, when a branch condition of a branch next to the branch is determined before the timing, the branch and the next branch.

(Supplementary Note 5)

The information processing apparatus according to Supplementary Note 4, wherein

the verification means stores, when verification for a first branch has been successfully completed, the branch information regarding the next branch whose branch condition has been determined, and

the verification means verifies integrity of the execution flow of the program using the stored branch information when the branch next to the first branch is verified.

(Supplementary Note 6)

The information processing apparatus according to any one of Supplementary Notes 1 to 5, wherein

the analysis means inserts a call for verification for the branch in the program, and

the verification means starts processing in accordance with the call inserted by the analysis means during execution of the program.

(Supplementary Note 7)

The information processing apparatus according to Supplementary Note 6, further comprising a secure execution environment in which the analysis means, the storage means, and the verification means are installed, wherein

the storage means stores a first eigenvalue regarding the call, and

the verification means periodically calculates a second eigenvalue regarding the call and compares the calculated second eigenvalue with the first eigenvalue, thereby verifying integrity of the call for verification.

(Supplementary Note 8)

An information processing method comprising:

analyzing a program before it is executed, extracting a branch in the program, and acquiring branch information regarding the branch and program part information regarding the part of the program that may be executed from a branch destination of the branch to a next branch;

storing the branch information, the program part information, and a first eigenvalue that is acquired in advance for the program part regarding the program part information and is used for verification; and

acquiring, when the program is executed and an execution part reaches the branch, a second eigenvalue used for verification for the program part and determining whether or not the second eigenvalue matches the first eigenvalue, thereby verifying integrity of the program part.

(Supplementary Note 9)

The information processing method according to Supplementary Note 8, comprising:

storing the branch information including a pair of a branch source address and a branch destination address; and

verifying the integrity of an execution flow of the program by determining whether or not a pair of a branch source address and a branch destination address of the program that is being executed is stored.

(Supplementary Note 10)

The information processing method according to Supplementary Note 8 or 9, comprising:

analyzing a timing when a branch condition of the branch in a program is determined and aggregating a plurality of branches; and

verifying the integrity of the program part for each of the branches that have been aggregated.

(Supplementary Note 11)

The information processing method according to Supplementary Note 10, comprising aggregating, when a branch condition of a branch next to the branch is determined before the timing, the branch and the next branch.

(Supplementary Note 12)

The information processing method according to Supplementary Note 11, comprising

storing, when verification for a first branch has been successfully completed, the branch information regarding the next branch whose branch condition has been determined, and

verifying integrity of the execution flow of the program using the stored branch information when the branch next to the first branch is verified.

(Supplementary Note 13)

The information processing method according to any one of Supplementary Notes 8 to 12, comprising:

inserting a call for verification for the branch in the program, and

starting processing in accordance with the inserted call during execution of the program.

(Supplementary Note 14)

The information processing method according to Supplementary Note 13, wherein

the analyzing, the storing, and the verifying are executed in a secure execution environment, and

the method comprises:
storing a first eigenvalue regarding the call; and
periodically calculating a second eigenvalue regarding the call and comparing the calculated second eigenvalue with the first eigenvalue, thereby verifying integrity of the call for verification.

(Supplementary Note 15)

A non-transitory computer readable medium storing a program for causing a computer to execute the following steps of:

analyzing a program before it is executed, extracting a branch in the program, and acquiring branch information regarding the branch and program part information regarding the part of the program that may be executed from a branch destination of the branch to a next branch;

storing the branch information, the program part information, and a first eigenvalue that is acquired in advance for the program part regarding the program part information and is used for verification; and

acquiring, when the program is executed and an execution part reaches the branch, a second eigenvalue used for verification for the program part and determining whether or not the second eigenvalue matches the first eigenvalue, thereby verifying integrity of the program part.

### REFERENCE SIGNS LIST

1 Information Processing Apparatus
2 Analysis Unit
4 Storage Unit
6 Verification Unit
100, 200, 300 Information Processing Apparatus
101 Controller
102 Program Storage Unit
103 Communication Unit
104, 204, 304 Analysis Unit
105 Verification Information Storage Unit
106, 206, 306 Verification Unit
301 Normal Space
302 Secure Space

What is claimed is:

1. An information processing apparatus comprising:
hardware, including a processor and memory;
analysis unit implemented at least by the hardware and configured to analyze a program before it is executed, extract a branch in the program, and acquire branch information regarding the branch and program part information regarding the part of the program that may be executed from a branch destination of the branch to a next branch;
storage unit implemented at least by the hardware and configured to store the branch information, the program part information, and a first eigenvalue that is acquired in advance for the program part regarding the program part information and is used for verification; and
verification unit implemented at least by the hardware and configured to acquire, when the program is executed and an execution part reaches the branch, a second eigenvalue used for verification for the program part and determine whether or not the second eigenvalue matches the first eigenvalue, thereby verifying integrity of the program part.

2. The information processing apparatus according to claim 1, wherein
the storage unit stores the branch information including a pair of a branch source address and a branch destination address, and
the verification unit verifies the integrity of an execution flow of the program by determining whether or not a pair of a branch source address and a branch destination address of the program that is being executed is present in the storage unit.

3. The information processing apparatus according to claim 1, wherein
the analysis unit analyzes a timing when a branch condition of the branch in a program is determined and aggregates a plurality of branches, and
the verification unit verifies the integrity of the program part for each of the branches that have been aggregated.

4. The formation processing apparatus according to claim 3, wherein the analysis unit aggregates, when a branch condition of a branch next to the branch is determined before the timing, the branch and the next branch.

5. The formation processing apparatus according to claim 4, wherein
the verification unit stores, when verification for a first branch has been successfully completed, the branch information regarding the next branch whose branch condition has been determined, and
the verification unit verifies integrity of the execution flow of the program using the stored branch information when the branch next to the first branch is verified.

6. The information processing apparatus according to claim 1, wherein
the analysis unit inserts a call for verification for the branch in the program, and
the verification unit starts processing in accordance with the call inserted by the analysis unit during execution of the program.

7. The formation processing apparatus according to claim 6, further comprising a secure execution environment in which the analysis unit, the storage unit, and the verification unit are installed, wherein
the storage unit stores a first eigenvalue regarding the call, and
the verification unit periodically calculates a second eigenvalue regarding the call and compares the calculated second eigenvalue with the first eigenvalue, thereby verifying integrity of the call for verification.

8. An information processing method comprising:
analyzing a program before it is executed, extracting a branch in the program, and acquiring branch information regarding the branch and program part information regarding the part of the program that may be executed from a branch destination of the branch to a next branch;
storing the branch information, the program part information, and a first eigenvalue that is acquired in advance for the program part regarding the program part information and is used for verification; and
acquiring, when the program is executed and an execution part reaches the branch, a second eigenvalue used for verification for the program part and determining whether or not the second eigenvalue matches the first eigenvalue, thereby verifying integrity of the program part.

9. The information processing method according to claim 8, comprising:
storing the branch information including a pair of a branch source address and a branch destination address; and
verifying the integrity of an execution flow of the program by determining whether or not a pair of a branch source address and a branch destination address of the program that is being executed is stored.

10. The information processing method according to claim 8, comprising:
analyzing a timing when a branch condition of the branch in a program is determined and aggregating a plurality of branches; and
verifying the integrity of the program part for each of the branches that have been aggregated.

11. The information processing method according to claim 10, comprising aggregating, when a branch condition of a branch next to the branch is determined before the timing, the branch and the next branch.

12. The information processing method according to claim 11, comprising:
storing, when verification for a first branch has been successfully completed, the branch information regarding the next branch whose branch condition has been determined, and
verifying integrity of the execution flow of the program using the stored branch information when the branch next to the first branch is verified.

13. The information processing method according to claim 8, comprising:
inserting a call for verification for the branch in the program, and
starting processing in accordance with the inserted call during execution of the program.

14. The information processing method according to claim 13, wherein
the analyzing, the storing, and the verifying are executed in a secure execution environment, and
the method comprises:
storing a first eigenvalue regarding the call; and
periodically calculating a second eigenvalue regarding the call and comparing the calculated second eigenvalue with the first eigenvalue, thereby verifying integrity of the call for verification.

15. A non-transitory computer readable medium storing a program for causing a computer to execute the following steps of:
analyzing a program before it is executed, extracting a branch in the program, and acquiring branch information regarding the branch and program part information regarding the part of the program that may be executed from a branch destination of the branch to a next branch;
storing the branch information, the program part information, and a first eigenvalue that is acquired in advance for the program part regarding the program part information and is used for verification; and
acquiring, when the program is executed and an execution part reaches the branch, a second eigenvalue used for verification for the program part and determining whether or not the second eigenvalue matches the first eigenvalue, thereby verifying integrity of the program part.
